(19) United States
(12) Patent Application Publication
(10) Pub. No.: US 2020/0142912 A1
(43) Pub. Date: May 7, 2020

(54) DATA PROCESSING DEVICE AND DATA PROCESSING PROGRAM

(71) Applicant: SHIMADZU CORPORATION, Kyoto-shi (JP)

(72) Inventors: Akira HARADA, Kyoto-shi (JP); Hidesato KUMAGAI, Kyoto-shi (JP); Kota OGINO, Kyoto-shi (JP)

(73) Assignee: SHIMADZU CORPORATION, Kyoto-shi (JP)

(21) Appl. No.: 16/675,681

(22) Filed: Nov. 6, 2019

(30) Foreign Application Priority Data
Nov. 6, 2018 (JP) 2018-209234

(51) Int. Cl. G06F 16/28; G06F 16/2455

(52) U.S. Cl. CPC G06F 16/285; G06F 16/24553

(57) ABSTRACT

A data processor is provided that classifies analysis object data items without performing complex operation in advance. A data processor 1 classifies a plurality of analysis object data items measured by electrophoresis. The data processor 1 includes: a comparison section 8 to perform comparison of the analysis object data items with each other by a predetermined comparison criterion; and a classification section 9 to perform classification of the analysis object data items by a predetermined classification criterion based on a result of the comparison by the comparison section 8 to divide the data items into groups. The comparison section 8 performs the comparison, using the analysis object data items as a reference data item one after another, of the reference data item with each of all the analysis object data items not subjected to the comparison with the reference data item.

### BACKGROUND OF THE INVENTION

### 1. Field of the Invention

The present invention relates to a data processor and a data processing program to classify data measured by electrophoresis.

### 2. Description of the Related Art

There is software for analysis and display of data measured by electrophoresis in which the measured data is displayed in the form of an electropherogram, a gel image, and the like and also peak detection is performed to output time, size, area, concentration, molarity, and the like on the detected peak (e.g., refer to JP 2015-114150 A). Some of such software creates an arbitrary conditional expression using the result of peak detection for data classification using the conditional expression.

For such data classification, however, an absolute value sometimes has to be input as a reference value for the conditional expression or a condition sometimes has to be set for each classification pattern. For classification of data detected with a plurality of peaks, many conditional expressions have to be created corresponding to the number of peaks. As just has been described, very complex operation has to be performed in advance for data classification.

### SUMMARY

The present invention has been made in view of the above problems and it is an object thereof to provide a data processor and a data processing program capable of data classification without performing complex operation in advance.

To achieve the above object, a data processor according to the present invention to classify a plurality of analysis object data items measured by electrophoresis, the data processor includes: a comparison section to perform comparison of the analysis object data items with each other by a predetermined comparison criterion; and a classification section to perform classification of the analysis object data items by a predetermined classification criterion based on a result of the comparison by the comparison section to divide the data items into groups.

Including the comparison section and the classification section as described above, the data processor according to the present invention allows classification that cannot be made by visual observation only by simple setting and thus reduction in the load of data processing.

In the above data processor, it is preferred that the comparison section performs the comparison, using the analysis object data items as a reference data item one after another, of the reference data item with each of all the analysis object data items not subjected to the comparison with the reference data item. It is preferred that the comparison section performs the comparison, using the analysis object data items as a reference data item one after another, of the reference data item with the analysis object data items in a group with a coincident number of peaks among the analysis object data items not subjected to the comparison with the reference data item or the analysis object data items in a group with a close number of peaks. It is also preferred that the comparison criterion is whether each of a plurality of peaks in one of the analysis object data items is in a range tolerable to coincide in size with each of a plurality of peaks in the other object data for comparison, and the classification criterion is a ratio to have the peaks in the analysis object data item coincident in size with each other. It is also preferred that the comparison criterion is correlation between one of the analysis object data items and the other analysis object data item shifted and compressed or expanded in a direction of a time axis, and the classification criterion is whether a value of the correlation between the analysis object data items with each other exceeds a threshold. It is also preferred that the comparison criterion is correlation between one of the analysis object data items and the other analysis object data item shifted in a direction of a time axis, and the classification criterion is whether a value of the correlation between the analysis object data items with each other exceeds a threshold. It is further preferred to include a display control section to display, on a display section, each of the analysis object data items in association with a sign and color indicating the corresponding group, only with the sign, or only with the color based on a result of the classification by the classification section.

A data processing program according to the present invention includes the data processor described above caused to execute: comparing to perform the comparison of the analysis object data items with each other; and classifying to perform the classification of the analysis object data items based on the result of the comparison by the comparing.

The present invention is capable of providing a data processor and a program that are capable of data classification without performing complex operation in advance as described above.

### BRIEF DESCRIPTION OF THE DRAWINGS

FIG. 1 is a block diagram illustrating the functional configuration of a data processor according to a first embodiment of the present invention.

FIG. 2 is a conceptual image illustrating a plurality of analysis object data items divided into groups by a classification section.

FIG. 3 is an image graphics illustrating a first display mode in a display section.

FIG. 4 is an image graphics illustrating a second display mode in the display section.

FIG. 5 is a flow chart illustrating a flow of data processing in the data processor.

### DETAILED DESCRIPTION OF THE PREFERRED EMBODIMENTS

Embodiments of the present invention are described below with reference to the drawings.

### First Embodiment

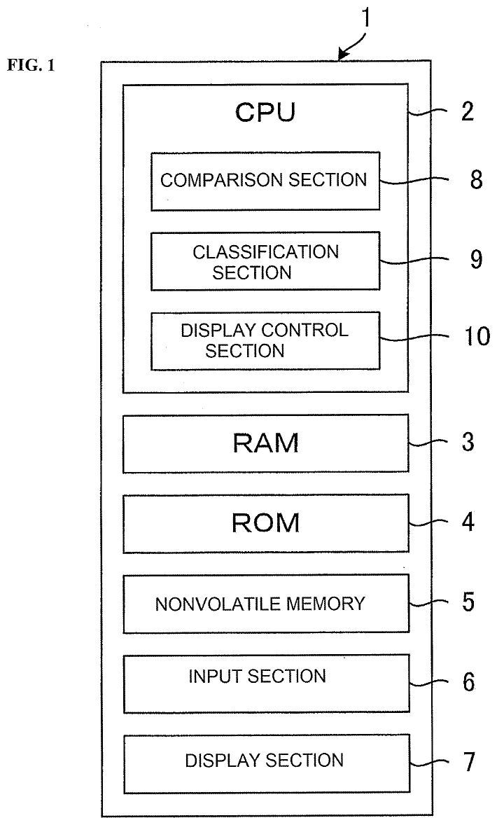

With reference to FIGS. 1 through 4, a data processor 1 according to the first embodiment of the present invention is described.

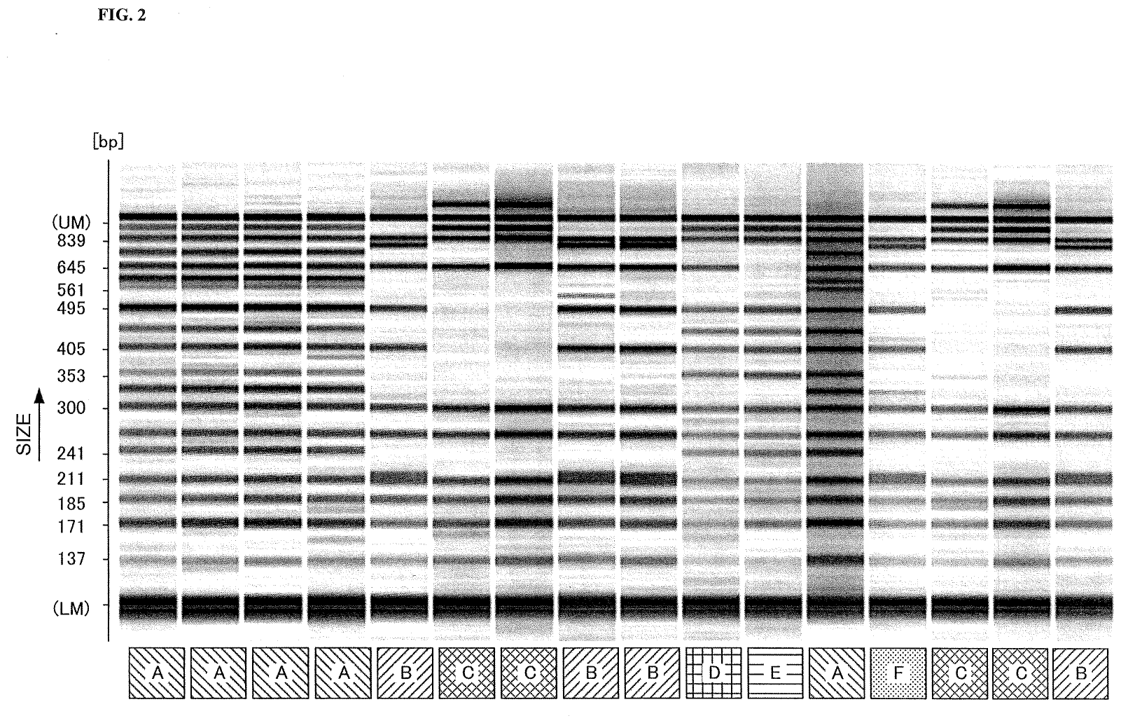

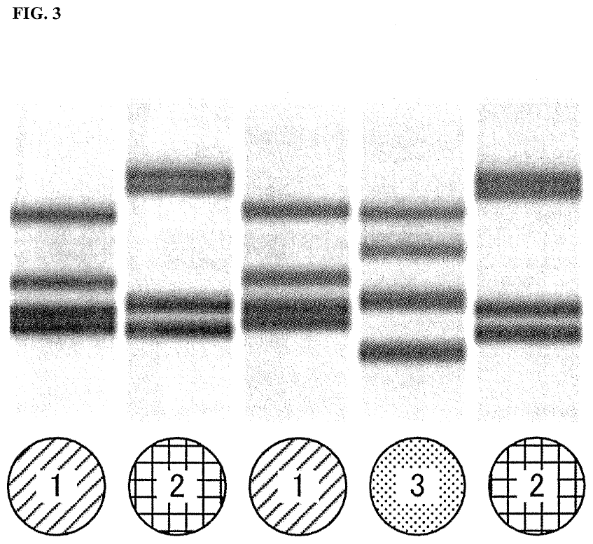

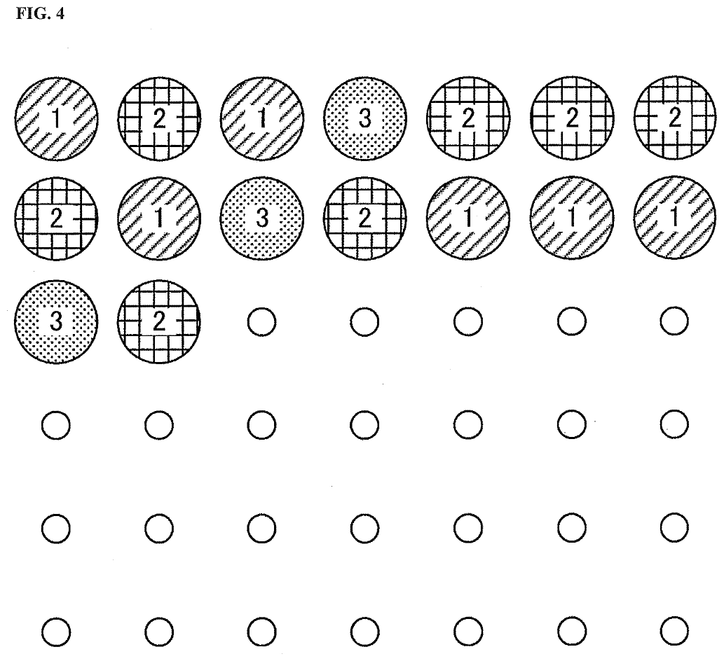

First, with reference to FIGS. 1 through 4, a description is given to the configuration of the data processor 1 according to this embodiment of the present invention. FIG. 1 is a block diagram illustrating the functional configuration of the data processor 1. FIG. 2 is a conceptual image illustrating a plurality of analysis object data items divided into groups by a classification section 9. FIG. 3 is an image graphics illustrating a first display mode in a display section 7. FIG. 4 is an image graphics illustrating a second display mode in the display section 7.

The data processor 1 illustrated in FIG. 1 is a device to classify a plurality of analysis object data items measured by electrophoresis and performs grouping using so-called “size tolerance (%)”. The data processor 1 is achieved by installing dedicated software (data processing program) on a general personal computer. Specifically, the data processor 1 includes a CPU 2, a RAM 3, a ROM 4, a nonvolatile memory 5, an input section 6, a display section 7, and the like.

The central processing unit (CPU) 2 achieves various functions, such as a comparison section 8, a classification section 9, and a display control section 10, by executing various programs to integrally control the data processor 1. The random access memory (RAM) 3 is used as a work area of the CPU 2. The read only memory (ROM) 4 memorizes a basic OS and various programs executed by the CPU 2.

The nonvolatile memory 5 stores various types of data, such as analysis object data items, data to be a predetermined comparison criterion, data to be a predetermined classification criterion, and data indicating a group. The input section 6 is a keyboard, a mouse, and the like to accept input by a user. The display section 7 is controlled by the display control section 10 to display various images.

The comparison section 8 performs comparison of a plurality of analysis object data items with each other by a predetermined comparison criterion to output the result of the comparison to the classification section 9. Specifically, the comparison section 8 sorts the analysis object data items in descending order of the number of peaks, followed by comparison of, using the analysis object data items as a reference data item one after another, the reference data item with each of all the analysis object data items not subjected to the comparison with the reference data item.

The comparison criterion here is whether each of a plurality of peaks in one of the analysis object data items is in a range tolerable to coincide in size with each of a plurality of peaks in the other object data for comparison (range of “size tolerance (%)”).

More specifically, after defining a first analysis object data item as the reference data item, the comparison section 8 performs comparison of the size of the peaks in the reference data item with the size of the peaks in the second and following analysis object data items. The comparison is performed based on whether the peaks in the analysis object data item to be compared is in a range of “size tolerance (%)” relative to the peaks in the reference data item.

For example, when the reference data item has a peak size of 561 and a size tolerance of 5%, the analysis object data item to be compared having a peak size greater than 534 (≈561/1.05) and not greater than 589 (≈561×1.05) is considered to have a peak in the range tolerable to coincide in size.

When the reference data item has two peak sizes that are close and have the ranges to overlap, a geometric mean is defined as a boundary value. For example, when the reference data item has peak sizes of 561 and 595, the boundary value is 577.7.

Then, after defining the second analysis object data item as the reference data item, the comparison section 8 performs comparison of the size of the peaks in the reference data item with the size of the peaks in the third and following analysis object data items. After that similarly, after defining each of the third and following analysis object data items as the reference data item, the comparison section 8 performs comparison of the size of the peaks in the reference data item with the size of the peaks in the following analysis object data items. As a result, the comparison section 8 performs the comparison of all the analysis object data items each other on a round-robin basis. The comparison objects in the comparison section 8 may be limited to, for example, analysis object data items in a group with a coincident number of peaks or analysis object data items in a group with a close number of peaks for any of size, fitting, alignment, and the like.

Based on the result of the comparison by the comparison section 8, the classification section 9 classifies the analysis object data items by a predetermined classification criterion and divides them into groups to output the result of the classification on the display control section 10. The classification criterion is whether all the peaks in the analysis object data items (are in a range tolerable to) coincide in size with each other. That is, the classification criterion is whether a ratio is 100% to have the peaks in the analysis object data items (in a range tolerable to be) coincident in size with each other.

As illustrated in FIG. 2, the analysis object data items are divided into groups by the classification section 9. The signs A through E indicated in the lower part of FIG. 2 are provided for the convenience of description, and the analysis object data items with an identical sign are divided into a group same as each other.

The description referring back to FIG. 1. The display control section 10 displays, on the display section 7, each of the analysis object data items in association with a sign and color indicating the corresponding group based on the result of the classification by the classification section 9. The association may be made only with the sign or only with the color.

As illustrated in FIG. 3, the result of grouping is displayed by giving a group ID and color of the ID to each gel image. In this case, the analysis object data items with a group ID “1” and color of the ID (e.g., red) are divided into a group same as each other.

Similarly, the analysis object data items with a group ID “2” and color of the ID (e.g., blue) and a group ID “3” and color of the ID (e.g., green) are divided into respective groups same as each other.

Alternatively, as illustrated in FIG. 4, the result of grouping is displayed similar to FIG. 3 on well display indicating the position where each measured sample is arranged.

If there is an analysis object data item that may fall under a plurality of groups, process is performed, such as classification of the analysis object data item into a group with an overall smaller difference and display of warning on the display section 7.

### Data Processing

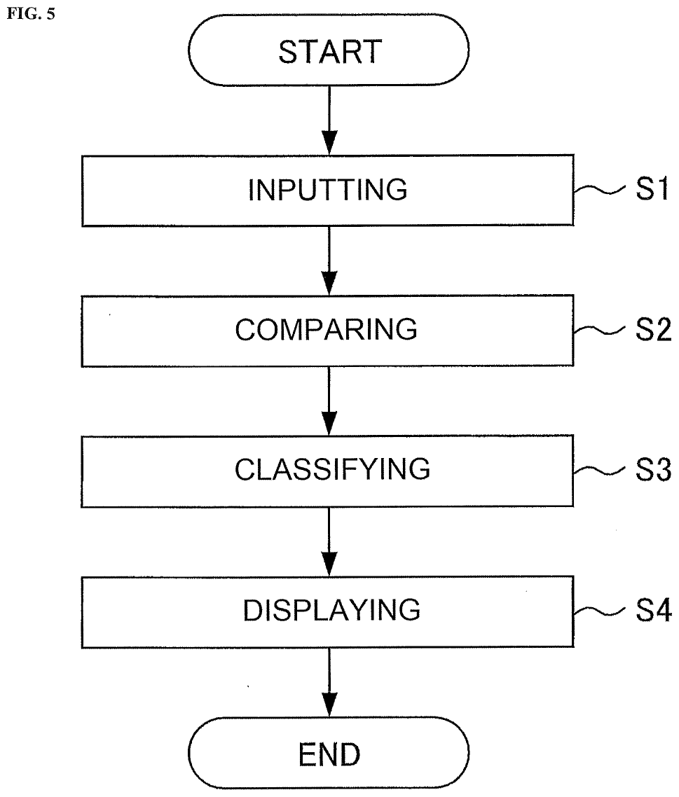

Then, with reference to FIG. 5, data processing by the data processor 1 is described. FIG. 5 is a flow chart illustrating a flow of data processing in the data processor 1.

As illustrated in FIG. 5, the data processor 1 executes inputting S1, comparing S2, classifying S3, and displaying S4 in this order.

The inputting S1 is a process of inputting analysis object data items and parameters by the input section 6 and the like. Basic parameters to be input include size tolerance (%). Optionally input parameters include a range of analysis objects (specified by the time, the size, normalized time with an internal standard marker, etc.) in the analysis object data items. When no change is made from a parameter input in the past, input of the parameter may be omitted.

The comparing S2 is a process of performing comparison of the analysis object data items with each other by the comparison section 8.

The classifying S3 is a process of performing classification of the analysis object data items by the classification section 9 based on the result of the comparison by the comparing S2.

The displaying S4 is a process of displaying, on the display section 7, each of the analysis object data items in association with a sign and color indicating the corresponding group by the display control section 10 based on the result of the classification by the classifying S3. In this process, the display may be made only in association with the sign or only with the color.

Effects of this Embodiment

In the first embodiment of the present invention, the following effects are obtained.

In the first embodiment, as described above, the data processor 1 to classify a plurality of analysis object data items measured by electrophoresis includes: a comparison section 8 to perform comparison of the analysis object data items with each other by a predetermined comparison criterion; and a classification section 9 to perform classification of the analysis object data items by a predetermined classification criterion based on a result of the comparison by the comparison section 8 to divide the data items into groups. This allows classification that cannot be made by visual observation only by simple setting and thus reduction in the load of data processing. That is, it is possible to perform data classification without performing complex operation in advance.

In the present embodiment, the comparison section 8 performs the comparison, using the analysis object data items as a reference data item one after another, of the reference data item with each of all the analysis object data items not subjected to the comparison with the reference data item. The comparison objects here may be limited to analysis object data items in a group with a coincident number of peaks or analysis object data items in a group with a close number of peaks.

In the present embodiment, the comparison criterion is whether each of a plurality of peaks in one of the analysis object data items is in a range tolerable to coincide in size with each of a plurality of peaks in the other object data for comparison, and the classification criterion is a ratio to have the peaks in the analysis object data item coincident in size with each other.

In the present embodiment, a display control section 10 is further included to display, on a display section 7, each of the analysis object data items in association with a sign and color indicating the corresponding group. The display may be made only in association with the sign or only with the color.

In the present embodiment, a data processing program includes the data processor 1 caused to execute: comparing S2 to perform the comparison of the analysis object data items with each other; and classifying S3 to perform the classification of the analysis object data items based on the result of the comparison by the comparing S2.

### Second Embodiment

Then, with reference to FIG. 1, a data processor 1 according to the second embodiment of the present invention is described. Different from the first embodiment where grouping is performed using the so-called “size tolerance (%)”, the second embodiment is configured to perform grouping using so-called “fitting (waveform fitting)”. The data processor 1 according to the second embodiment has the configuration similar to that in the first embodiment and the description on the same configuration is omitted as appropriate.

The comparison section 8 performs comparison of the analysis object data items with each other by a predetermined comparison criterion to output the result of the comparison to the classification section 9. Specifically, the comparison section 8 performs the comparison, using the analysis object data items as a reference data item one after another, of the reference data item with each of all the analysis object data items not subjected to the comparison with the reference data item. The comparison criterion is correlation between one of the analysis object data items and the other analysis object data item shifted and compressed or expanded in the direction of a time axis.

More specifically, after defining a first analysis object data item as the reference data item, the comparison section 8 performs fitting (shifting and compression or expansion in the direction of the time axis) of the second and following analysis object data items to the reference data item to obtain a value of the correlation with the reference data item. Then, after defining the second analysis object data item as the reference data item, the comparison section 8 performs fitting of the third and following analysis object data items to the reference data item to obtain a value of the correlation with the reference data item.

After that similarly, after defining each of the third and following analysis object data items as the reference data item, the comparison section 8 performs fitting of the following analysis object data items to the reference data item to obtain a value of the correlation with the reference data item. As a result, the comparison section 8 performs the comparison of all the analysis object data items each other on a round-robin basis.

Based on the result of the comparison by the comparison section 8, the classification section 9 classifies the analysis object data items by a predetermined classification criterion and divides them into groups to output the result of the classification on the display control section 10. The classification criterion is whether a value of the correlation between the analysis object data items with each other exceeds a threshold. That is, the classification section 9 classifies the analysis object data items having a value of the correlation higher than a threshold as a group same as each other. For details of the “fitting”, refer to, for example, JP 2018-025536 A by the applicant of the present application.

If there is an analysis object data item that may fall under a plurality of groups, process is performed, such as classification of the analysis object data item into a group with a high value of the correlation and display of warning on the display section 7.

Basic parameters to be input by the input section 6 and the like include “a shift tolerance” and “a compression/expansion tolerance” for fitting. Optionally input parameters input by the input section 6 and the like include a threshold to determine as the identical group and a range of analysis objects (specified by the time, the size, normalized time with an internal standard marker, etc.) in the analysis object data items.

### Third Embodiment

Then, with reference to FIG. 1, a data processor 1 according to the third embodiment of the present invention is described. Different from the first embodiment where grouping is performed using the so-called “size tolerance (%)” and the second embodiment where grouping is performed using the so-called “fitting”, the third embodiment is configured to perform grouping using so-called “alignment (waveform alignment)”.

The data processor 1 according to the third embodiment has the configuration similar to that in the first and second embodiments and the description on the same configuration is omitted as appropriate.

The comparison section 8 performs comparison of the analysis object data items with each other by a predetermined comparison criterion to output the result of the comparison to the classification section 9. Specifically, the comparison section 8 performs the comparison, using the analysis object data items as a reference data item one after another, of the reference data item with each of all the analysis object data items not subjected to the comparison with the reference data item. The comparison criterion is correlation between one of the analysis object data items and the other analysis object data item shifted in the direction of a time axis.

More specifically, after defining a first analysis object data item as the reference data item, the comparison section 8 performs alignment (shifting in the direction of the time axis) of the second and following analysis object data items to the reference data item to obtain a value of the correlation with the reference data item. Then, after defining the second analysis object data item as the reference data item, the comparison section 8 performs alignment of the third and following analysis object data items to the reference data item to obtain a value of the correlation with the reference data item.

After that similarly, after defining each of the third and following analysis object data items as the reference data item, the comparison section 8 performs alignment of the following analysis object data items to the reference data item to obtain a value of the correlation with the reference data item. As a result, the comparison section 8 performs the comparison of all the analysis object data items each other on a round-robin basis.

Based on the result of the comparison by the comparison section 8, the classification section 9 classifies the analysis object data items by a predetermined classification criterion and divides them into groups to output the result of the classification on the display control section 10. The classification criterion is whether a value of the correlation between the analysis object data items with each other exceeds a threshold. That is, the classification section 9 classifies the analysis object data items having a value of the correlation higher than a threshold as a group same as each other.

If there is an analysis object data item that may fall under a plurality of groups, process is performed, such as classification of the analysis object data item into a group with a high value of the correlation and display of warning on the display section 7.

Basic parameters to be input by the input section 6 and the like include “a shift tolerance” for alignment. Optionally input parameters input by the input section 6 and the like include a threshold to determine as the identical group and a range of analysis objects (e.g., specified by the time, the size, normalized time with an internal standard marker, etc.) in the analysis object data items.

### Modifications

All the above embodiments should be considered as exemplification in all aspects and not to be restrictive. The scope of the present invention is shown by the appended claims not by the above description of the embodiments and further includes all alterations (modifications) within the meaning and scope equivalent to the claims.

For example, although the classification criterion by the classification section 9 in the first embodiment is whether all the peaks in the analysis object data items (are in a range tolerable to) coincide in size with each other, the present invention is not limited to this. That is, in the present invention, the classification criterion by the classification section 9 is a ratio to have the peaks in the analysis object data items (in a range tolerable to be) coincident in size with each other and the ratio does not have to be 100%.

1. A data processor to classify a plurality of analysis object data items measured by electrophoresis, the data processor comprising:
a comparison section to perform comparison of the analysis object data items with each other by a predetermined comparison criterion; and
a classification section to perform classification of the analysis object data items by a predetermined classification criterion based on a result of the comparison by the comparison section to divide the data items into groups.

2. The data processor according to claim 1, wherein the comparison section performs the comparison, using the analysis object data items as a reference data item one after another, of the reference data item with each of all the analysis object data items not subjected to the comparison with the reference data item.

3. The data processor according to claim 1, wherein the comparison section performs the comparison, using the analysis object data items as a reference data item one after another, of the reference data item with the analysis object data items in a group with a coincident number of peaks among the analysis object data items not subjected to the comparison with the reference data item or the analysis object data items in a group with a close number of peaks.

4. The data processor according to claim 1, wherein the comparison criterion is whether each of a plurality of peaks in one of the analysis object data items is in a range tolerable to coincide in size with each of a plurality of peaks in the other object data for comparison, and
the classification criterion is a ratio to have the peaks in the analysis object data item coincident in size with each other.

5. The data processor according to claim 1, wherein the comparison criterion is correlation between one of the analysis object data items and the other analysis object data item shifted and compressed or expanded in a direction of a time axis, and
the classification criterion is whether a value of the correlation between the analysis object data items with each other exceeds a threshold.

6. The data processor according to claim 1, wherein the comparison criterion is correlation between one of the analysis object data items and the other analysis object data item shifted in a direction of a time axis, and
the classification criterion is whether a value of the correlation between the analysis object data items with each other exceeds a threshold.

7. The data processor according to claim 1, further comprising a display control section to display, on a display section, each of the analysis object data items in association with a sign and color indicating the corresponding group, only with the sign, or only with the color based on a result of the classification by the classification section.

8. A data processing program, comprising the data processor according to claim 1 caused to execute:
comparing to perform the comparison of the analysis object data items with each other; and
classifying to perform the classification of the analysis object data items based on the result of the comparison by the comparing.
